(19) United States
(12) Patent Application Publication
(10) Pub. No.: US 2014/0123932 A1
(43) Pub. Date: May 8, 2014

(54) CONTROL METHOD AND APPARATUS FOR DUAL INJECTOR OF ENGINE

(71) Applicant: HYUNDAI MOTOR COMPANY, Seoul (KR)

(72) Inventors: Hyung Ju LEE, Seoul (KR); II Nam LEE, Hwaseong-si (KR)

(73) Assignee: Hyundai Motor Company, Seoul (KR)

(21) Appl. No.: 13/722,564

(22) Filed: Dec. 20, 2012

(30) Foreign Application Priority Data
Nov. 5, 2012 (KR) 10-2012-0124050

(51) Int. Cl. F02B 17/00

(52) U.S. Cl. CPC F02B 17/005
USPC 123/294

(57) ABSTRACT

It is possible to improve fuel efficiency with improved combustion performance of an engine by increase volatility of fuel supplied to a combustion chamber as much as possible and can reduce toxic exhaust substances, by appropriately controlling injection of two injectors in an engine with a dual injector.

### CROSS-REFERENCE TO RELATED APPLICATION

The present application claims priority of Korean Patent Application Number 10-2012-0124050 filed Nov. 5, 2012, the entire contents of which application is incorporated herein for all purposes by this reference.

### BACKGROUND OF INVENTION

1. Field of Invention

The present invention relates to controlling injection of fuel by controlling an injector in an engine, and more particularly, to controlling a dual injector that is supposed to supply fuel from two injectors to the same combustion chamber in an engine.

2. Description of Related Art

Engines of the related art are generally equipped with only one injector and it is required to inject fuel through the injector even in a period when an intake valve is not open, in order to supply a sufficient amount of fuel that is in a sufficiently vaporized state to a corresponding chamber.

However, injecting fuel with the intake valve not open causes wall wetting of the fuel on the wall of the intake port, so that the fuel efficiency and the toxic exhaust substances are adversely affected.

On the other hand, in dual injector engines, in order to improve fuel efficiency by increasing a volume efficiency and to reduce toxic substances, as illustrated in FIG. 1, an injector 502 is disposed in each of two intake ports 500 that communicate with one combustion chamber and fuel can be appropriately supplied to the combustion chamber by controlling the two injectors 502.

In an engine with the dual injector 502 described above, volatility of fuel supplied to the combustion chamber depends on how much harmoniously the injectors 502 disposed in the intake ports 500 are controlled, the volatility of the fuel has a large influence on burning of the engine, and consequently, this causes a considerable change in fuel efficiency and toxic exhaust substances of a vehicle.

The information disclosed in this Background section is only for enhancement of understanding of the general background of the invention and should not be taken as an acknowledgement or any form of suggestion that this information forms the prior art already known to a person skilled in the art.

### SUMMARY OF INVENTION

The present invention has been made in an effort to solve the above-described problems associated with prior art.

Various aspects of the present invention provide for a control method for a dual injector of an engine which can improve fuel efficiency with improved combustion performance of an engine by increase volatility of fuel supplied to a combustion chamber as much as possible and can reduce toxic exhaust substances, by appropriately controlling injection of two injectors in an engine with a dual injector.

Various aspects of the present invention provide for a control method for a dual injector of an engine that controls a first injector and a second injector disposed in two intake ports, respectively, which is connected to one combustion chamber, in which injection times of the first injector and the second injector have temporal priority.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a diagram illustrating an exemplary part of an intake port of an engine equipped with a dual injector where the present invention is applied.

FIG. 2 is a flowchart illustrating an exemplary control method for a dual injector of an engine according to the present invention.

FIG. 3 is a diagram illustrating an exemplary configuration of a control apparatus for a dual injector of an engine according to the present invention.

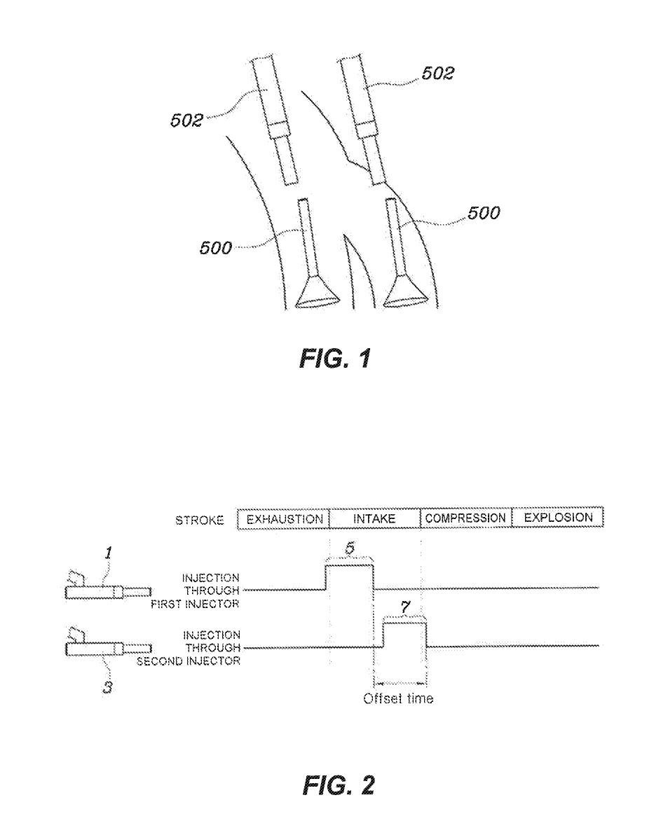

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Referring to FIG. 2, a control method for a dual injector of an engine of the present invention offsets the injection times of a first injector 1 and a second injector 3 with temporal priority, in an engine equipped with the first injector 1 and the second injector 3 disposed in two intake ports, respectively, which are connected to one combustion chamber.

That is, the different injection times of the first injector 1 and the second injector 3 are controlled with a time interval, a wide time distribution where vaporization of fuel occurs in a fuel-gas mixture supplied into a combustion chamber is ensured such that volatility of the fuel is more improved, so that, consequently, it is possible to improve fuel efficiency of a vehicle by improving combustion performance of an engine and to reduce toxic exhaust substances.

In various embodiments, the injection time 5 of the first injector 1 and the injection time 7 of the second injector 3 may be continuously formed by one time, respectively.

That is, when there is one time of injection of the first injector 1, time is continuous and there is also one time of injection of the second injector 3, and the time is continuous without disconnecting.

Obviously, although it is possible to provide the first injector 1 and the second injector with a plurality number of times of injection times, the first injector 1 and the second injector 3 may have one number of time of injection, respectively, as in the above embodiments, which have the advantage of being able to be applied even to an injector with relatively low responsiveness.

The injection time of the first injector 1 and the injection time of the second injector 3 may be switched during a valve-open time with the intake valve open.

That is, the injection time of the first injector 1 and the injection time of the second injector are generally disposed in an intake stroke with the intake valve open, the injection times of the first injector 1 and the second injector 3 are offset, and conversion of the injection times of the first injector 1 and the second injector 3 is within the open period of the intake valve.

Disposing the injection times in the intake stroke is for most injected fuel to be supplied to a combustion chamber by minimizing wall wetting on the intake port, by allowing the fuel to be injected with the intake valve open as long as it can.

It is advantageous to prevent the injection times of the first injector 1 and the second injector 3 from overlapping, in that fuel can have a change to vaporize in contact with air for a relatively long time without rushing at a time.

However, the injection times of the first injector 1 and the second injector 3 may partially overlap in order to satisfy a difference in intake flow of two intake port or other combustion conditions.

Meanwhile, the injection time of the first injector 1 starts at least before the intake valve opens.

That is, injection of the first injector 1 with an earlier injection time starts not later than when the intake valve opens such that fuel can be injected while using the period with the intake valve open as much as possible; therefore, injection starts, when the intake valve opens, even if the injection time of the first injector 1 is slightly earlier or later than when the intake valve opens in consideration of the inertia and speed of the intake flow.

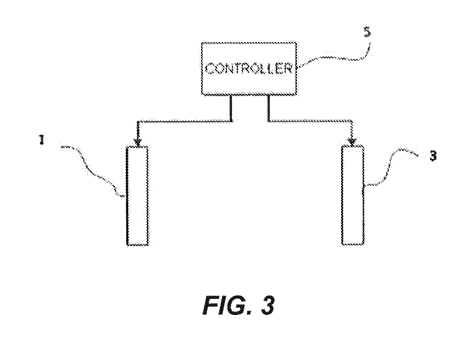

Further, as illustrated in FIG. 3, it is possible to implement a control apparatus for a dual injector of an engine including a controller 5 that controls the first injector 1 and the second injector 2 in accordance with the method described above, and obviously, it is possible to implement a vehicle equipped with the control apparatus.

The vehicle may include hybrid vehicles recently coming into the market.

According to the present invention, it is possible to improve fuel efficiency with improved combustion performance of an engine by increase volatility of fuel supplied to a combustion chamber as much as possible and can reduce toxic exhaust substances, by appropriately controlling injection of two injectors in an engine with a dual injector.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A control method for a dual injector of an engine, comprising:
controlling a first injector and a second injector disposed in first and second intake ports, respectively, connected to one combustion chamber, wherein injection times of the first injector and the second injector have temporal priority.

2. The method of claim 1, wherein an injection interval of the first injector and an injection interval of the second injector are continuous.

3. The method of claim 2, wherein the injection interval of the first injector and the injection interval of the second injector are switched during a valve-open time with the intake valve open.

4. The method of claim 3, wherein the injection interval of the first injector and the injection interval of the second injector do not overlap.

5. The method of claim 3, wherein the injection interval of the first injector and the injection interval of the second injector partially overlap.

6. The method of claim 3, wherein the injection interval of the first injector starts at least before the intake valve opens.

7. A control apparatus for a dual injector of an engine comprising;
a first injector and a second injector disposed in first and second intake ports, respectively, connected to one combustion chamber; and
a controller that controls the first injector and the second injector in accordance with the method according to claim 1.

8. A vehicle comprising;
a first injector and a second injector disposed in first and second intake ports, respectively, connected to one combustion chamber; and
a controller that controls the first injector and the second injector in accordance with the method according to claim 2.

9. A vehicle comprising;
a first injector and a second injector disposed in first and second intake ports, respectively, connected to one combustion chamber; and
a controller that controls the first injector and the second injector in accordance with the method according to claim 3.

10. A vehicle comprising;
a first injector and a second injector disposed in first and second intake ports, respectively, connected to one combustion chamber; and
a controller that controls the first injector and the second injector in accordance with the method according to claim 4.

11. A vehicle comprising;
a first injector and a second injector disposed in first and second intake ports, respectively, connected to one combustion chamber; and
a controller that controls the first injector and the second injector in accordance with the method according to claim 5.

12. A vehicle comprising;
a first injector and a second injector disposed in first and second intake ports, respectively, connected to one combustion chamber; and
a controller that controls the first injector and the second injector in accordance with the method according to claim 6.
